(19) United States
(12) Patent Application Publication
(10) Pub. No.: US 2002/0106085 A1
(43) Pub. Date: Aug. 8, 2002

(54) Security breach management

(76) Inventors: Sandeep Jain, Belmont, CA (US); Sudheer Thakur, Belmont, CA (US); Kevin Darryl Jeu, Santa Clara, CA (US); Sanjay Ghatare, San Jose, CA (US)

Correspondence Address: Hickman Palermo Truong & Becker LLP, 1600 Willow Street, San Jose, CA, 95125-5106, US

(21) Appl. No.: 09/755,851

(22) Filed: Jan. 5, 2001

(51) Int. Cl. H04L 9/00

(52) U.S. Cl. 380/277

(57) ABSTRACT

Techniques for handling a breach in security are disclosed. According to one technique, prior to the breach, a first party sends to a second party data that identifies a plurality of public keys, including a current public key that corresponds to a current private key. The second party uses the current public key and the first party uses the current private key to exchange electronic messages securely. Other keys, including a session key, may also be used to ensure the security of the exchange. According to one technique, digital signatures are attached to every outgoing message during the secure exchange, and verified on every incoming message. In response to a breach involving the current private key, (1) the first party invalidates the current private key, (2) the first party sends a message to the second party to instruct the second party to invalidate the current public key, and to establish another public key in the plurality of public keys as a new current public key. After the second party receives the message, the second party uses the new current public key and the first party uses a corresponding new current private key to exchange electronic messages securely.

### FIELD OF THE INVENTION

The present invention relates to security management and, more specifically, to techniques for responding to security breaches.

### BACKGROUND OF THE INVENTION

Society's reliance on computer systems is ever-increasing. With the increase in reliance comes an increase in the need for security. Specifically, it is critical for a company that engages in electronic commerce to know that the party with whom communications are being exchanged is the party that the company believes it to be. For example, a company that allows an accounting firm to electronically retrieve and process its salary, sales and inventory information would want to be very sure that the company with whom it is exchanging the information is, in fact, the designated accounting firm. Such assurance is critical when the transmission of confidential information takes place over a network to which many other parties have access (such as the Internet).

### Secure Communication

Cryptography is the art and science of keeping messages secure. A message is information or data that is arranged or formatted in a particular way. In general, a message, sometimes referred to as “plaintext” or “cleartext,” is encrypted or transformed using a cipher to create “ciphertext,” which disguises the message in such a way as to hide its substance. In the context of cryptography, a cipher is a mathematical function that can be computed by a data processor. Once received by the intended recipient, the ciphertext is decrypted to convert the ciphertext back into plaintext. Ideally, ciphertext sufficiently disguises a message in such a way that even if the ciphertext is obtained by an unintended recipient, the substance of the message cannot be discerned from the ciphertext.

Many different encryption/decryption approaches for protecting information exist. In general, the selection of an encryption/decryption scheme depends upon the considerations such as the types of communications to be made more secure, the particular parameters of the network environment in which the security is to be implemented, and desired level of security. An important consideration is the particular system on which a security scheme is to be implemented, since the level of security often has a direct effect on system resources.

For example, for small applications that require a relatively low level of security, a traditional restricted algorithm approach may be appropriate. With a restricted algorithm approach, a group of participants agree to use a specific, predetermined algorithm to encrypt and decrypt messages exchanged among the participants. Because the algorithm is maintained in secret, a relatively simple algorithm may be used. However, in the event that the secrecy of the algorithm is compromised, the algorithm must be changed to preserve secure communication among the participants. Scalability, under this approach, is an issue. As the number of participants increases, keeping the algorithm secret and updating it when compromises occur place an undue strain on network resources. In addition, standard algorithms cannot be used since each group of participants must have a unique algorithm.

To address the shortcomings of traditional restricted algorithm approaches, many contemporary cryptography approaches use a key-based algorithm. Generally two types of key-based algorithms exist: (1) symmetric algorithms and (2) asymmetric algorithms, of which one example is a public key algorithm. As a practical matter, a key forms one of the inputs to a mathematical function that is used by a processor or computer to generate a ciphertext.

Public key algorithms are designed so that the key used for encryption is different than the key used for decryption. These algorithms are premised on the fact that the decryption key cannot be determined from the encryption key, at least not in any reasonable amount of time with practical computing resources. Typically, the encryption key (public key) is made public so that anyone, including an eavesdropper, can use the public key to encrypt a message. However, only a specific participant in possession of the decryption key (private key) can decrypt the message. Thus, the owner of a public key requests all parties that wish to send the owner an encrypted message, to encrypt the message using the public key of the owner. All messages thus encrypted can only be decrypted by the owner, using the owner's corresponding private key.

The public key technique is generally used to establish a secure data communication channel through key exchanges among the participants. Two or more parties, who wish to communicate over a secure channel, exchange or make available to each other public (or non-secure) key values. Each party uses the other party's public key value to privately and securely compute a private key, using an agreed-upon algorithm. The parties then use their derived private keys in a separate encryption algorithm to encrypt messages passed over the data communication channel. Conventionally, these private keys are valid only on a per communication session basis, and thus, are referred to as session keys. These session keys can be used to encrypt/decrypt a specified number of messages or for a specified period of time.

A typical scenario involves participants party A and party B, in which party A is considered a publisher of a message to a subscriber, party B. The public key algorithm used to establish a secure channel between publisher, party A, and subscriber, party B, is as follows:

Party B provides a public key, B, to party A.

Party A generates a random session key SK, encrypts it using public key B and sends it to party B.

Party B decrypts the message using private key, b ( to recover the session key SK).

Both party A and party B use the session key SK to encrypt their communications with each other; after the communication session, party A and party B discard SK.

The above approach provides the added security of destroying the session key at the end of a session, thereby, providing greater protection against eavesdroppers.

### Authenticating Public Keys

In the scenario described above, it is assumed that the entity that sent the public key to party A was really party B. If party B is not the party that sent the public key to party B, then security has been compromised because party A has merely prevented some eavesdroppers for obtaining sensitive information by establishing a secure connection with a party which is itself an eavesdropper.

One technique used to verify the true public key of a party employs a trusted third party authentication mechanism, such as a certificate authority (“CA”) to regulate the exchange of keys. In a certificate authority scheme, a party that desires to participate in a secure communication may apply for a digital certificate from a CA. Upon verifying the identity of the requestor, the CA sends to the requestor a digital certificate. A digital certificate is an encrypted message which, when decrypted, produces the requestor's public key and information that identifies the requestor. The mechanism used by the CA to encrypt the digital certificate is known only to the CA. However, the CA publishes a key that may be used to decrypt its certificates.

Thus, instead of sending its public key to party A, party B sends to party A the digital certificate that it received from CA. Party A decrypts the digital certificate using the public decryption key of CA. If the digital certificate is authentic (i.e. was really issued by CA), then the public decryption key of CA will successfully decrypt the digital certificate to produce the public key of party B, and the identity of party B. If the identity information thus produced indicates that party B is the party with which party A desires to communicate, then party A can be assured that messages that it encrypts using the public key that was contained in the certificate can only be decrypted by party B.

### Authenticating Sender Identity

The party that sends to party A the digital certificate of party B may simply be pretending to be party B. If A believes that the party is party B, and encrypts all messages to the party using party B's public key, then the party should not be able to decrypt the messages unless the party actually is party B. An impostor would receive the messages, but be unable to decrypt them.

However, it is often not enough for party A to know that the messages that it intends for party B can only be decrypted by party B. It is often just as important that party A knows that the messages that it believes to be from party B are actually from party B. One technique for verifying the identity of the sender of a message involves the use of digital signatures. A digital signature is a code that can be attached to an electronically transmitted message to guarantee that the entity sending the message is really who it claims to be. Most digital signature mechanisms use a private digital signature key to encrypt the message digest (or method fingerprint) using the private key to generate digital signature, and a public digital signature key to decrypt the digital signature. If the public key of party B successfully decrypts a digital signature attached to a message, then party A can be assured that party B was the sender of the message. A typically exchange of a digitally signed message would proceed as follows:

Party A provides to party B the public digital signature key of party A.

Party A creates a message to send to party B.

Party A applies a one-way hash function to the message to create a hash value, also referred to as the message digest or method fingerprint.

Party A creates a digital signature by encrypting the hash value using the private digital signature key of party A.

Party A sends the message to party B, with the digital signature attached.

Party B creates a first hash value by applying the same one-way hash function to the message.

Party B creates a second hash value by decrypting the digital signature using the public digital signature key of party A.

Party B compares the first hash value to the second hash value. If the two hash values are equal, then party A was the true sender of the message.

Based on the foregoing, each party to a secure communication may have two pairs of keys. The first set of keys would include a private decryption key and a public encryption key. The public encryption key would be used by others to encrypt messages to be sent to the party. The private decryption key would be used by the party to decrypt those messages. These keys would generally be used for the handshaking that takes place prior to establishing a secure connection.

The second set of keys would include a private digital signature key and a public digital signature key. The private digital signature key would by used to create digital signatures to use with outgoing messages. The public digital signature key would be used by recipients of those messages to verify the identity of the sender.

In spite of these security mechanisms, it is possible for a security breach to occur. For example, an eavesdropper may wrongfully acquire a private key of one of the parties. When such a breach occurs, it is critical for the actual parties to re-establish secure communications as soon as possible with minimal disruption to the information exchange.

### SUMMARY OF THE INVENTION

Techniques for handling a breach in security are disclosed. According to one technique, prior to the breach, a first party sends to a second party data that identifies a plurality of public keys, including a current public key that corresponds to a current private key. The second party uses the current public key and the first party uses the current private key to exchange electronic messages securely. Other keys, including a session key, may be used to ensure the security of the exchange. According to one technique, digital signatures are attached to every outgoing message during the secure exchange, and verified on every incoming message.

In response to a breach involving the current private key, (1) the first party invalidates the current private key, (2) the first party sends a message to the second party to instruct the second party to invalidate the current public key, and to establish another public key in the plurality of public keys as a new current public key. After the second party receives the message, the second party uses the new current public key and the first party uses a corresponding new current private key to exchange electronic messages securely.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating steps for initiating a partner relationship according to an embodiment of the invention;

FIG. 2 is a flowchart illustrating steps for conducting a secure exchange of electronic information according to an embodiment of the invention;

FIG. 3 is a flowchart illustrating steps for handling a security breach according to an embodiment of the invention; and

FIG. 4 is a block diagram of a computer system on which embodiments of the invention may be implemented.

### DETAILED DESCRIPTION OF THE PREFERRED EMBODIMENT

Techniques are described for setting up and conducting secure communications, and for handling security breaches in such communications. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Terminology

Techniques are provided for allowing parties to communicate securely over a network that may include eavesdroppers. For the purpose of illustration, the techniques shall be described in the context of a system that includes a commerce hub and one or more entities (“partners”) that require interaction with the commerce hub. However, the present techniques are not limited to communications between any particular type of entities.

For the purpose of explanation, the following terminology shall be used:

### A Partner's Incoming Messages

Ppublic-encrypt-key: the public key used to encrypt messages to be sent to a partner.

Ppublic-key-certificate: the certificate issued by a trusted party to authenticate the Ppublic-encrypt-key.

Pprivate-decrypt-key: the private key used by the partner to decrypt messages that are encrypted using the Ppublic-encrypt-key.

As explained above, these keys are used primarily during the handshaking phase to establish a secure session.

### A Partner's Outgoing Messages

Message hash value: a hash value created by applying a one-way hash function to a message.

Pprivate-digital-signature-key : the private key used by a partner to encrypt message hash values to produce digital signatures.

Ppublic-digital-signature-key: the public key used to decrypt the digital signature of the partner.

Pdigital-signature-certificate: the certificate issued by a trusted party to authenticate Ppublic-digital-signature-key.

### The Commerce Hub's Incoming Messages

CHpublic-encrypt-key: the public key used to encrypt messages to be sent to a commerce hub.

CHpublic-encrypt-key-certificate: the certificate issued by a trusted party to authenticate CHpublic-encrypt-key.

CHprivate-decrypt-key: the private key used by the commerce hub to decrypt messages that are encrypted using CHpublic-encrypt-key.

These keys are used primarily during the handshaking phase to establish a secure session.

### The Commerce Hub's Outgoing Messages

CHprivate-digital-signature-key: the private key used by the commerce hub to encrypt message hash values to produce the commerce hub's digital signatures.

CHpublic-digital-signature-key: the public key used to decrypt the digital signature of the commerce hub.

CHdigital-signature-certificate: the certificate issued by a trusted party to authenticate CHpublic-digital-signature-key.

### The Certificate Authority

Certificate_encrypt_key: the private key used by the certificate authority to encrypt certificates.

Certificate_decrypt_key: the public key used to decrypt certificates issued by the certificate authority.

### Initiating a Partner Relationship

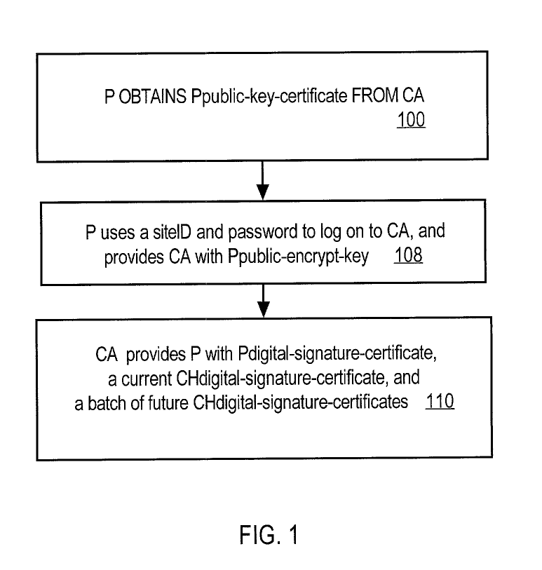

According to one embodiment, a party that desires to communicate securely with a commerce hub establishes itself as a partner as shown in FIG. 1.

At step 100, the party obtains a Ppublic-key-certificate from a trusted third party (e.g. a certificate authority). The Ppublic-key-certificate is an encrypted message that includes the public encryption key of the party (Ppublic-encrypt-key), as well as data identifying the party.

At step 108, the partner uses the siteID and password to log on to the commerce hub. While logged on to the commerce hub, the partner enters a company profile, including the Ppublic-encrypt-key of the partner.

In response to the partner logging on, the commerce hub has a certificate authority create a new partner digital certificate for the partner. The new partner certificate is a Pdigital-signature-certificate that includes a Ppublic-digital-signature-key and data that identifies the partner. The commerce hub also adds the network address of the partner to the list of addresses with which it will allow secure connections to be established.

At step 119, a certificate authority (e.g. the Viquity CA) then provides the following information to the partner:

(1) the new Pdigital-signature-certificate,

(2) a current CHdigital-signature-certificate, and

(3) a batch of future CHdigital-signature-certificates.

The current CHdigital-signature-certificate is a certificate, issued by a certificate authority, that includes the current public digital signature key of the commerce hub (CHpublic-digital-signature-key) and data that identifies the commerce hub. The partner uses Certificate_decrypt_key to decrypt the current CHdigital-signature-certificate and thereby obtain the current CHpublic-digital-signature-key.

The current CHpublic-digital-signature-key is the key required to successfully decrypt the digital signatures that the commerce hub is currently sending with its outgoing messages.

The batch of future CHdigital-signature-certificates is an ordered set of one or more certificates for CHpublic-digital-signature-keys that do not decrypt the digital signatures that the commerce hub is currently using. Rather, the certificates in the batch of future CHdigital-signature-certificates are for CHpublic-digital-signature-keys that are to be used to decrypt the digital signatures that the commerce hub will generate in the future, in the event of a security breach. How the batch of certificates is used to efficiently handle hub-side security breaches shall be described in detail below.

### Conducting a Secure Communication Exchange

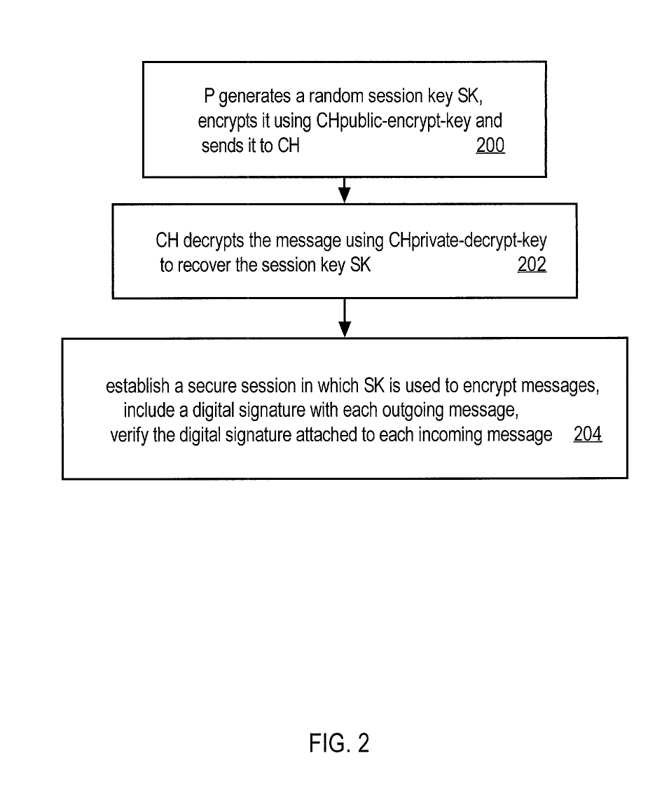

Having initiated a partner relationship using the technique described above, a partner may conduct a secure communication with the commerce hub. Specifically, the partner is in possession of CHpublic-encrypt-key, the current CHpublic-digital-signature-key, and a batch of future CHpublic-digital-signature-keys. The commerce hub is in possession of Ppublic-digital-signature-key, and has added the network address of the partner to the list of addresses with which it will establish a secure connection. According to one embodiment, the secure communication exchange is conducted as illustrated in FIG. 2.

At step 200, the partner generates a random session key SK, encrypts it using CHpublic-encrypt-key and sends it to the commerce hub. Included with the message is the digital signature of the partner, generated by the partner using Pprivate-digital-signature-key. Upon the receipt of this and all subsequent messages, the commerce hub verifies that the message is from an address with which it permits the establishment of a secure connection. The commerce hub uses the Ppublic-digital-signiture-key to verify the identity of the sender. Assuming that the digital signature decrypts properly, then at step 202, the commerce hub decrypts the message using CHprivate-dencrypt-key to recover the session key SK.

During the session, both the partner and the commerce hub use the session key SK to encrypt their communications with each other. However, rather than merely rely on the security provided by the session key SK encryption, each of the participants in the session additionally attaches its digital signature to each of its outgoing messages. This communication is illustrated at step 204.

Specifically, the partner attaches to each of its outgoing messages a digital signature that is generated using Pprivate-digital-signature-key. The commerce hub attaches to each of its outgoing messages a digital signature that is generated using the CHprivate-digital-signature-key that is associated with the current CHpublic-digital-signature-key.

Similarly, each of the participants in the secure session check each incoming message for the valid digital signature of the party with which it is communicating. Thus, the partner uses the current CHpublic-digital-signature-key to validate the digital signatures on each incoming message during the session. Conversely, the commerce hub uses the current Ppublic-digital-signature-key to validate the digital signatures on each incoming message during the session. At the end of the session, all participants discard the SK.

Various events may indicate that a security breach has occurred during the session. For example, if either participant receives a message that does not contain the authentic digital signature of the other participant, then the SK key may have been stolen. In addition, either participant may discover that their private-encrypt-key has been stolen. How such security breaches are handled, according to one embodiment of the invention, shall now be described.

### Responding to Security Breaches

When a partner discovers that the Pprivate-digital-signature-key used to generate the digital signature of the partner has been stolen, the partner informs the commerce hub. The commerce hub then discards the Ppublic-digital-signature-key and Pdigital-signature-certificate for that partner. After the Ppublic-digital-signature-key and Pdigital-signature-certificate have been discarded by the commerce hub, neither the partner nor the party that stole the partner's private key will be able to communicate securely with the commerce hub because they will not be able to produce digital signatures that will be accepted by the commerce hub.

According to one embodiment, to re-qualify as a partner, the partner then repeats the steps described above to (1) obtain a new Pprivate-digital-signature-key, a new Ppublic-digital-signature-key, and a new Pdigital-signature-certificate, and (2) communicate the Pdigital-signature-certificate securely to the commerce hub. The partner can then re-establish a secure communication with the commerce hub.

Secure communication is severed between the partner and the commerce hub during the time required for the partner to apply for, obtain, and communicate a new Pdigital-signature-certificate to the commerce hub. It may be commercially feasible for such a severance to temporarily occur between the commerce hub and one of its partners, but not for it to occur simultaneously between the commerce hub and all of its partners. Thus, if the CHprivate-digital-signature-key is stolen, it may not be commercially feasible for the commerce hub to cease communicating with all of its partners until it obtains a new CHprivate-digital-signature-key, and a corresponding CHpublic-digital-signature-key and CHdigital-signature-certificate.

According to one embodiment, the total shutdown of the commerce hub is avoided through the use of the CHpublic-digital-signature-key batches that have been pro-actively distributed to the partners of the commerce hub. Specifically, the commerce hub has, prior to the breach, obtained numerous CHprivate-digital-signature-keys, each of which has a corresponding CHpublic-digital-signature-key, and CHdigital-signature-certificate. The commerce hub assigns an order to the CHprivate-digital-signature-keys and, preferably, maintains each CHprivate-digital-signature-key in a secure location separate from the other CHprivate-digital-signature-keys.

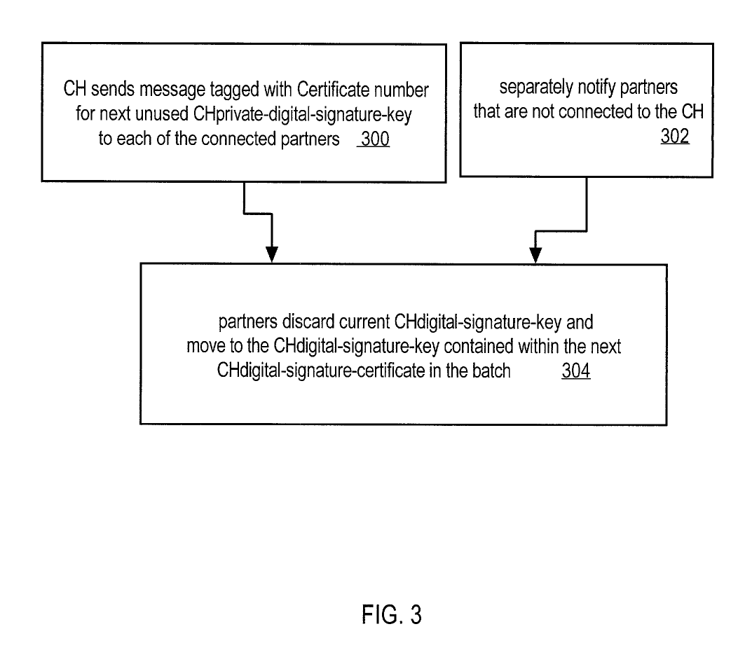

As mentioned above, the commerce hub sends the CHdigital-signature-certificates that correspond to the CHprivate-digital-signature-keys in an ordered batch to each partner at the time the partner relationship is established. A certificate number uniquely identifies each CHdigital-signature-certificate in the batch. When the commerce hub believes that the current CHprivate-digital-signature-key has been compromised, the commerce hub sends a message tagged with the certificate number corresponding to the next unused CHprivate-digital-signature-key to each of the connected partners, as shown in step 300 of FIG. 3. This message indicates to the partners that the CHpublic-digital-signature-key that they have been using is no longer valid, and that the new “current” CHpublic-digital-signature-key that they should use is the CHpublic-digital-signature-key corresponding to the certificate number contained within the next CHdigital-signature-certificate in the batch (step 304). The partners that are not connected to the commerce hub for a long time and did not receive a current batch of CHdigital-signature-certificates are separately notified of the change (step 302). For example, prior to establishing any secure connection, a partner may issue a SynchUpCertscommand. In response to this command, the commerce hub indicates which CHdigital-signature-certificate is “current”. Alternatively, the commerce hub may automatically send e-mail to the partners that do not have current batch of CHdigital-signature-certificates. Thus, at any given time, the CHpublic-digital-signature-key that is used by the partners of the commerce hub is the CHpublic-digital-signature-key that is highest in the batch order of those that have not been invalidated by the commerce hub.

As each CHdigital-signature-certificate is invalidated, the number of future CHdigital-signature-certificates left in the batch is reduced. To prevent partners from running out of future CHdigital-signature-certificates, new batches of CHdigital-signature-certificates may be periodically provided to partners. For example, the commerce hub may be configured to provide a new batch of CHdigital-signature-certificates to each partner when the number of future CHdigital-signature-certificates that have been sent to the partner drops below a given threshold.

By obtaining and distributing to partners future CHdigital-signature-certificates before they are needed, security breaches may be handled without terminating communication between the commerce hub and all of its partners. The ability to reestablish secure communication after a breach is critical in situations, for example, where the services provided by the commerce hub must be continuously available.

### Variations

In the embodiment described above, the commerce hub obtained, prior to a breach, (1) numerous key pairs for making digital signatures, and (2) certificates for the public digital signature keys in each of those key pairs. The commerce hub then disseminated those certificates securely prior to any breach, along with the order in which they would be used in response to breaches. As described, the embodiment includes many details that may vary from implementation to implementation. For example, the public keys for which the commerce hub obtains and disseminates a batch of certificates may be public encryption keys, rather than public digital signature keys. In such an implementation, the partners could use a “current” one of the public encryption keys to encrypt messages sent to the commerce hub. If the corresponding private decryption key is stolen, then the commerce hub may inform all of the partners to move to the next public encryption key.

In addition, all participants in the system, not just the commerce hub, may use the proactive batch transmission of certificates to reduce the amount of time required to re-establish secure transmission after a breach. For example, rather than send the hub a single public digital signature key, each partner may send the commerce hub a batch of public digital signature keys. Consequently, the technique of quickly switching to a “next” key may be employed for partner-side breaches as well as for hub-side breaches.

### Hardware Overview

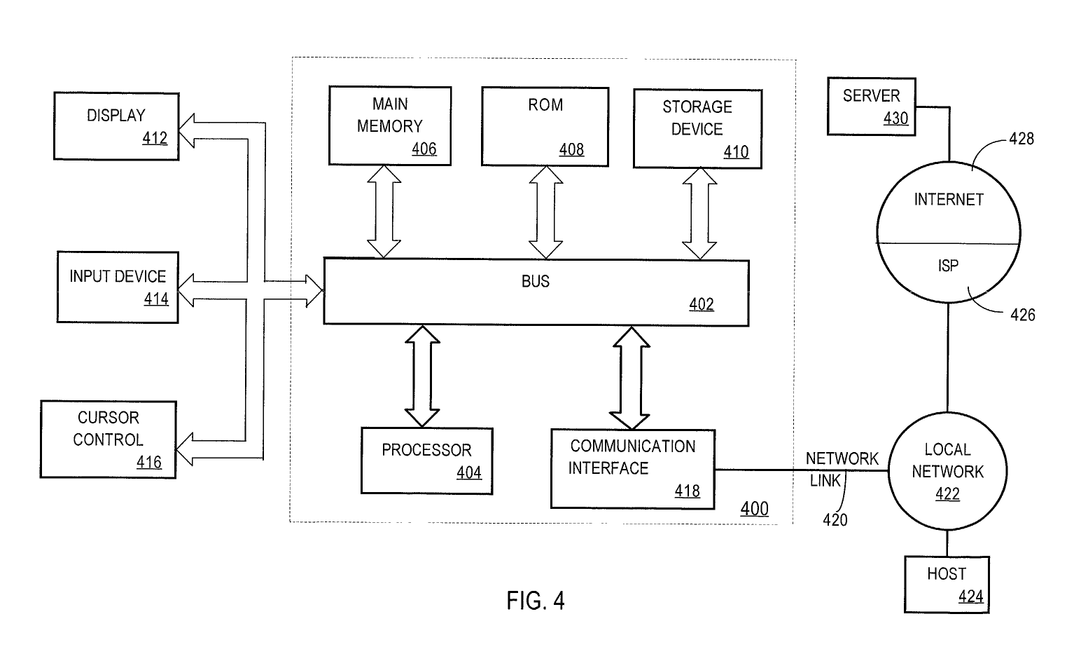

FIG. 4 is a block diagram that illustrates a computer system 400 upon which an embodiment of the invention may be implemented. In particular, computer system 400 may implement a commerce hub configured to operate as described above, or may be configured to operate as a partner to the commerce hub, as described above. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are implemented by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application implements the techniques described herein.

The received code may be executed by processor 404 as it is received, and/or stored in storage device 410, or other non-volatile storage for later execution. In this manner, computer system 400 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for handling a breach in security, the method comprising the steps of:
prior to the breach, a first party sending to a second party data that identifies a plurality of public keys, including a current public key that corresponds to a current private key;
prior to the breach, the second party using said current public key and the first party using the current private key to exchange electronic messages securely;
in response to the breach, performing the steps of
the first party invalidating said current private key;
the first party sending a message to said second party to instruct said second party to invalidate said current public key, and to establish another public key in said plurality of public keys as a new current public key;
after said second party receives said message, said second party using said new current public key and said first party using a corresponding new current private key to exchange electronic messages securely.

2. The method of claim 1 wherein:
the step of, prior to the breach, a first party sending to a second party data that identifies a plurality of public keys includes the first party sending to the second party a plurality of public keys for use in decoding digital signatures of the first party;
the plurality of public keys includes said current public key for digital signatures currently being used by the first party, and one or more other public keys for future use; and
the step of the second party using said current public key and the first party using the current private key to exchange electronic messages securely includes the step of the second party using said current public key to decode digital signatures received from said first party, and the first party using the current private key to generate digital signatures sent to said second party.

3. The method of claim 1 wherein the step of a first party sending to a second party data that identifies a plurality of public keys is performed by said first party sending to said second party certificates that include said plurality of public keys, wherein said certificates are encrypted by a certificate authority using a private encryption key.

4. The method of claim 1 further comprising the steps of:
establishing an order for the plurality of public keys; and
communicating said order to said second party;
wherein the message instructs said second party to invalidate said current public key, and to establish another public key in said plurality of public keys as a new current public key by instructing said second party to move to the public key of said plurality of public keys that is next in said order after said current public key.

5. The method of claim 1 further comprising the steps of:
prior to the breach, the second party sending to the first party data that identifies a second public key that is associated with a second private key maintained by said second party; and
wherein, in addition to said public key, the second party also uses said second private key to exchange electronic messages securely with said first party;
wherein, in addition to said current private key, the first party also uses said second public key to exchange electronic messages securely with said second party;
in response to theft of the second private key, the second party obtains a certificate from a certificate authority for a third public key associated with a third private key, the second party sending the certificate to the first party.

6. The method of claim 1 wherein:
said second party is one of a plurality of partners of said first party;
prior to the breach, the first party sends to each partner of said plurality of partners data that identifies said plurality of public keys;
prior to said breach, each partner of said plurality of partners uses said current public key for secure communications with said first party; and
in response to said breach, said first party sends a message to each partner of said plurality of partners that are currently connected to said first party, wherein said message instructs said partner to invalidate said current public key, and to establish another public key in said plurality of public keys as a new current public key.

7. A method for conducting a secure exchange of electronic information, the method comprising the steps of:
a first party sending to a second party a first message that is encrypted using a first public encryption key, the first message containing a session key;
said second party using a first private decryption key to decrypt said first message and extract said session key;
establishing a secure session between said first party and said second party using said session key, wherein all messages communicated between said parties during said session are encrypted using said session key;
said first party signing each message sent to said second party in said secure session using digital signatures generated using a first private digital signature key, wherein said first private digital signature key corresponds to a first public digital signature key;
said second party signing each message sent to said first party in said secure session using digital signatures generated using a second private digital signature key, wherein the second private digital signature key corresponds to a second public digital signature key;
said first party verifying that each message received during said secure session is authentic by applying said second public digital signature key to digital signatures received by said first party during said secure session; and
said second party verifying that each message received during said secure session is authentic by applying said first public digital signature key to digital signatures received by said second party during said secure session.

8. A system for handling a breach in security, the system comprising:
a first computer system associated with a first party;
a second computer system associated with a second party;
a network operatively connection said first computer system to said second computer system, wherein access to said network is not exclusively controlled by said first party or said second party;
wherein said first computer system is configured to, prior to said breach, send to said second computer system data that identifies a plurality of public keys, including a current public key that corresponds to a current private key;
wherein the first and second computer systems are configured to exchange electronic messages securely, prior to said breach, in a session during which said second computer uses said current public key and the first computer system uses the current private key;
wherein the first and second computers are configured to respond to the breach by performing the following steps:
the first computer system invalidates said current private key;
the first computer system sends a message to said second computer system to instruct said second computer system to invalidate said current public key, and to establish another public key in said plurality of public keys as a new current public key;
the second computer system invalidates said current public key and establishes the other public key as the new current public key;
wherein, after said second computer system receives said message, said second computer system uses said new current public key and said first computer system uses a corresponding new current private key to exchange electronic messages securely.

9. The system of claim 8 wherein:
the plurality of public keys are public keys for use in decoding digital signatures of the first party;
the plurality of public keys includes said current public key for digital signatures currently being used by the party, and one or more other public keys for future use; and
the second computer system uses said current public key to decode digital signatures received from said first computer system, and the first computer system uses the current private key to generate digital signatures sent to said second computer system.

10. The system of claim 8 wherein the data that identifies a plurality of public keys includes certificates that include said plurality of public keys, wherein said certificates are encrypted by a certificate authority using a private encryption key.

11. The system of claim 8 wherein:
the plurality of public keys are assigned an order; and
the order is communicated to said second computer system;
wherein the message instructs said second computer system to invalidate said current public key, and to establish another public key in said plurality of public keys as a new current public key by instructing said second computer system to move to the public key of said plurality of public keys that is next in said order after said current public key.

12. The system of claim 8 wherein:
prior to the breach, the second computer system sends to the first computer system data that identifies a second public key that is associated with a second private key maintained by said second computer system; and
wherein, in addition to said public key, the second computer system also uses said second private key to exchange electronic messages securely with said first computer system;
wherein, in addition to said current private key, the first computer system also uses said second public key to exchange electronic messages securely with said second computer system;
in response to theft of the second private key, the second computer system obtains a certificate from a certificate authority for a third public key associated with a third private key, the second computer system sends the certificate to the first computer system.

13. The system of claim 8 wherein:
said second party is one of a plurality of partners of said first party;
prior to the breach, the first computer system sends to computer systems of each partner of said plurality of partners data that identifies said plurality of public keys;
prior to said breach, the computer systems of each partner of said plurality of partners uses said current public key for secure communications with said first computer system; and
in response to said breach, said first computer system sends a message to the computer systems of each partner of said plurality of partners that are currently connected to said first computer system, wherein said message instructs said computer system to invalidate said current public key, and to establish another public key in said plurality of public keys as a new current public key.

14. A system for conducting a secure exchange of electronic information, the system comprising:
a first computer system configured to send to a second computer system a first message that is encrypted using a first public encryption key, the first message containing a session key;
said second computer system configured to use a first private decryption key to decrypt said first message and extract said session key;
wherein said first and second computer systems establish a secure session using said session key, wherein all messages communicated between said first and second computer systems during said session are encrypted using said session key;
said first computer system signing each message sent to said second computer system in said secure session using digital signatures generated using a first private digital signature key, wherein said first private digital signature key corresponds to a first public digital signature key;
said second computer system signing each message sent to said first computer system in said secure session using digital signatures generated using a second private digital signature key, wherein the second private digital signature key corresponds to a second public digital signature key;
said first computer system verifying that each message received during said secure session is authentic by applying said second public digital signature key to digital signatures received by said first computer system during said secure session; and
said second computer system verifying that each message received during said secure session is authentic by applying said first public digital signature key to digital signatures received by said second computer system during said secure session.
